(19) United States
(12) Patent Application Publication
(10) Pub. No.: US 2026/0211769 A1
(43) Pub. Date: Jul. 23, 2026

(54) AUTOMATED TROUBLESHOOTING AND RESOLUTION SYSTEM AND METHOD FOR PROVIDING CUSTOMER SUPPORT USING INTEGRATED PROGRAMMATIC AND SPECIALIZED GUIDED AND CONSTRAINED ARTIFICIAL INTELLIGENCE

(71) Applicant: Skyvera, LLC, Austin, TX (US)

(72) Inventors: Arthur Michel, Brooklyn, NY (US); Colin Guilfoyle, Drogheda (IE)

(73) Assignee: Skyvera, LLC, Austin, TX (US)

(21) Appl. No.: 19/369,061

(22) Filed: Oct. 24, 2025

Related U.S. Application Data
(60) Provisional application No. 63/711,694, filed on Oct. 24, 2024.

(51) Int. Cl. G06F 11/07

(52) U.S. Cl. CPC G06F 11/0793

(57) ABSTRACT

An exemplary automated troubleshooting and resolution system guides an artificial intelligence (AI) engine to perform automated troubleshooting and resolution in a customer support environment. This system uses a user interface data module to collect and store data. The user data includes real-time session data, which holds information about the issues the customer is facing, and live screen data. The system shares the user data with a customer support system, which creates a zip file with the received data and generates a prompt in a prompt generator for automated troubleshooting and resolution. The AI engine analyzes the zip file along with the prompt from the prompt generator and resolves the customer's issue. If the AI engine cannot solve the issue, the AI engine raises a support ticket for manual resolution.

### CROSS-REFERENCE TO RELATED APPLICATION(S)

This application claims the benefit under 35 U.S.C. § 119(e) and 37 C.F.R. § 1.78 of U.S. Provisional Application No. 63/711,694, which is incorporated by reference in its entirety.

### FIELD OF THE INVENTION

The present invention relates in general to the field of electronics, and more specifically to a system and method for guiding an AI engine for providing automated troubleshooting and resolution.

### BACKGROUND

Manual data capture, where the customers will manually capture screenshots or network logs when the customer faces any issues. The manual data capture requires technical knowledge and can be cumbersome. The manual data capture takes time and will not be consistent throughout. The customers must learn to use specific software, understand which data to capture, and ensure they collect all relevant information. The collection of data frequently leads to frustration and errors, as customers may miss critical details or capture incomplete data.

Separate ticket submission process, where customer must first capture the necessary data. Then customers need to navigate to the support platform and manually create a ticket. Next, customers must attach the captured data to the ticket and describe the issue in detail. The multi-step separate ticket submission process takes time and increases the chances of mistakes. Each additional step adds complexity, delaying issue resolution. Consequently, the separate ticket submission process is less efficient and prone to errors.

AI-powered chatbots without integrated capture tools are available, where customer needs to manually provide data about the issues. Customer must describe their problems and gather relevant information themselves. The AI-powered chatbots then attempt to resolve the issue based solely on the provided input. The AI-powered chatbots lack real-time insights into the customers environment. The limitation can result in incomplete diagnoses and less accurate solutions. As a result, customers may experience slower resolution times and added manual efforts.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary automated troubleshooting and resolution system.

FIG. 2 depicts an exemplary automated troubleshooting and resolution method utilized by the exemplary automated troubleshooting and resolution system.

FIG. 3 depicts a process flow for the exemplary automated troubleshooting and resolution method, which is an embodiment of the exemplary automated troubleshooting and resolution method of FIG. 2.

FIG. 4 depicts the information flow for the exemplary automated troubleshooting and resolution method, which is an embodiment of the exemplary automated troubleshooting and resolution method of FIG. 2.

FIG. 5 depicts a data structure for the exemplary automated troubleshooting and resolution system.

FIG. 6-9 depicts the user interface with an error message and a pop-up page from the exemplary automated troubleshooting and resolution system.

FIG. 10 depicts an exemplary network environment in which the system of FIG. 1 and the process of FIG. 2 may be practiced.

FIG. 11 depicts an exemplary computer system.

### DETAILED DESCRIPTION

An exemplary automated troubleshooting and resolution system 100 guides an artificial intelligence (AI) engine 120 to perform automated troubleshooting and resolution in a customer support environment. This system uses a user interface 104 to collect and store data such as user data 108, which includes real-time session data 124 holding information about the issues the customer is facing, and live screen data 110. The system shares the user data 108 with a customer support system 116, which creates a zip file of the received data. The customer support system 116 also generates a prompt using a prompt generator 118 for automated troubleshooting and resolution. The customer support system 116 shares the zipped file and the generated prompt with an AI engine 120, which an analyzes the zipped file and the prompt to resolve the customer's issue. If the AI engine 120 cannot solve the issue, the AI engine 120 raises a support ticket 122 for manual resolution.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

The exemplary automated troubleshooting and resolution system and an exemplary automated troubleshooting and resolution method utilized by the exemplary automated troubleshooting and resolution system ensure data privacy and security during capture and transferring data.

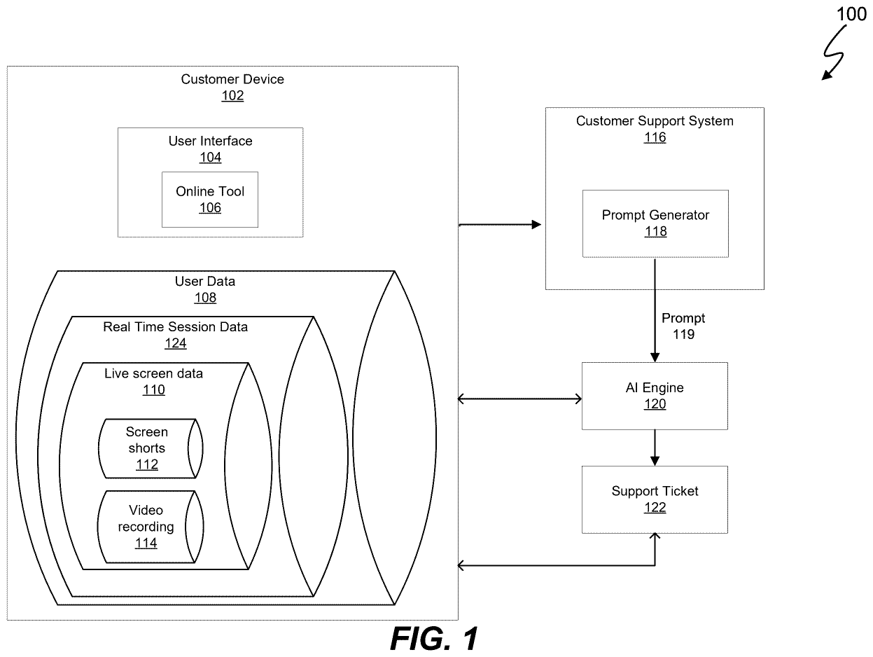

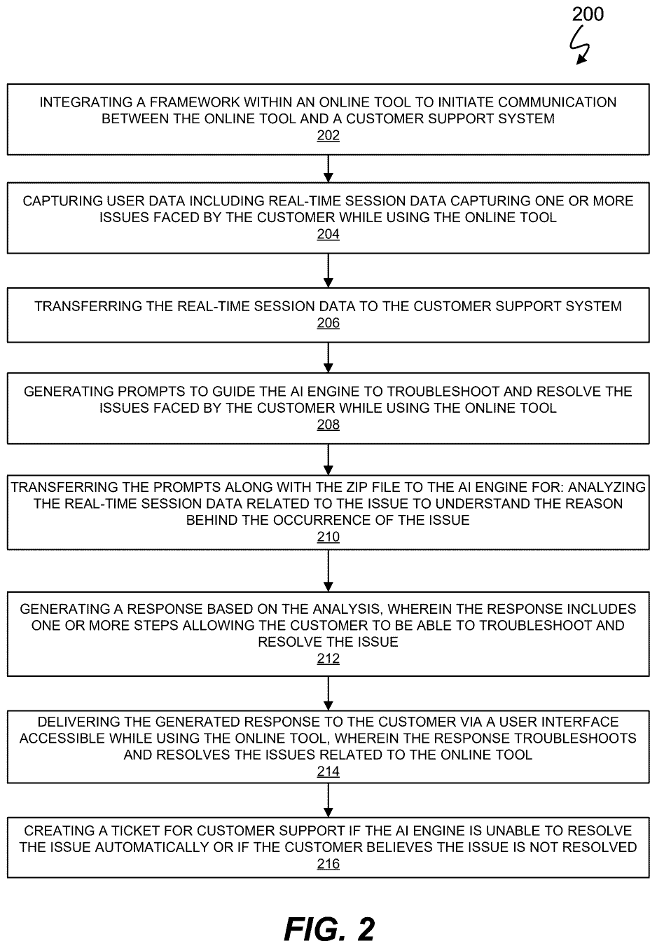

FIG. 1 depicts an exemplary automated troubleshooting and resolution system 100, and FIG. 2 depicts an exemplary automated troubleshooting and resolution method 200 utilized by the exemplary automated troubleshooting and resolution system 100.

Referring to FIGS. 1 and 2, in operation 202, integrating a framework within an online tool 106 to initiate communication between the online tool 106 and the customer support system 116. In at least one embodiment, the framework can be a browser extension or a feature of the online tool 106. The browser extension is a small software module or add-on that enhances the functionality of a web browser. The browser extension integrates directly into the browser to add new features or modify existing ones without altering the core browser itself. The feature of the online tool 106 refers to a specific functionality or capability. The online tool 106 integrates with the customer support system 116, allowing two-way communication. This two-way communication allows transfers of data between a customer device 102 and the customer support system 116.

In at least one embodiment, the communication between the online tool 106 and the customer support system 116 can be done through a mobile application where a mobile camera is used for the communication between the online tool 106 and the customer support system 116.

In operation 204, capturing the user data 108, including real-time session data 124, captures one or more issues faced by the customer while using the online tool 106, wherein the user data 108 refers to any information that is collected from or about a user while they interact with the online tool 106. The user data 108 is collected in real time when the user is using the online tool 106. For example, when the user navigates through the setting in the online tool 106, the user data 108 will collect the relevant information about the navigation in real time. A real-time session data 124 is used to store the real-time data collected from the online tool 106. Wherein the real-time session data 124 also captures the live screen data 110, which includes real-time information captured from the customer device 102 while the user is interacting with the online tool 106. The live screen data 110 includes a screenshots 112, videos recordings 114, mouse movements, clicks, and keystrokes. The screenshot 112 captures an image of the visible content on a screen. The videos recordings 114 is capturing video of all the activities taking place on the customer device 102. In at least one embodiment, when the mobile application is used for the communication between the online tool 106 and the customer support system 116, mobile camera is used for taking photos of the screen instead of the screenshots 112 and live videos are taken instead of videos recordings 114.

The exemplary automated troubleshooting and resolution method provides an option for the customer to choose between capturing the user data 108 by manually triggering or allowing the customer device 102 to monitor and collect the user data 108. If monitoring is required, the customer device 102 can capture the live screen data to track the health of the user applications. For example, if a user is not comfortable monitoring and collecting the user data 108, the user can opt for manual collection of the user data 108.

In at least one embodiment, the user data 108 includes HTTP Archive (HAR) files for additional insights. Wherein the HAR file records the interactions between a web browser and a website. The HAR file captures detailed information about requests and responses, including headers, cookies, and timing data. The HAR files are used to analyze web performance and troubleshoot issues.

A Python program (“background.js”) used to collect the data from the customer device 102 is:

The above mentioned python code begins by initializing variables and setting up a constant ‘API ENDPOINT’. The code then defines ‘createSessionUUID( )’ function for session initialization, which generates a unique session ID for each user interaction. The session initialization refers to the process of setting up a new session for a user interaction. The session initialization typically occurs when a user first interacts with a system, such as logging into a web application or starting a new transaction.

A root message listener is a central component in the code that listens for incoming messages or events from different sources and handles them by routing the messages to specific functions. ‘setProductName( )’ function sets the product being analyzed. ‘requestPermissionsAndStartCapturing( )’ function initiates the data capture process. ‘endCapturing( )’ function stops the data collection and processes the gathered information. ‘manualUploadData( )’ function allows for manual file uploads. ‘solveQuery( )’ function sends captured data to the server for analysis. ‘closeTicket( )’ function and ‘leaveTicketOpen( )’ function manage the support tickets.

The extension implements tab event listeners. These use ‘injectContentScript( )’ function to inject the content script into the correct tab and ‘startCapturing( )’ function to begin data collection when tabs are updated or switched. ‘startCapturing( )’ function manages the core data capture process. The ‘startCapturing( )’ function attaches a debugger to the active tab, enables network debugging, and sets up listeners for network events and console logs. ‘endCapturing( )’ function finalizes the capture process, including taking a screenshot with ‘chrome.tabs.captureVisibleTab( )’ function.

Utility functions include ‘createHARFile( )’ function for generating HTTP Archive (HAR) files, ‘uploadData( )’ function for sending data to the server, and ‘base64Encode( )’ function for encoding data. ‘createCredentials( )’ function manages user authentication, while ‘solveQuery( )’ function sends captured data to the customer support system 116 for analysis. The code also includes ‘validateAndCorrectJSON( )’ function for ensuring data integrity and ‘removeImagePrefix( )’ function for processing image data. ‘terminateProcesses( )’ function and ‘clearAllData( )’ function handle cleanup operations when the extension is stopped or reset.

The Python code developed by the software engineers for additional functions for a browser extension, on error handling and console log capture:

```
  //#region Override console log
  let logs = [ ];
  const originalLog = console.log;
  console.log = function (...args) {
    logs.push(args);
    originalLog.apply(console, args);
  };
  //#endregion
  //#region Message listener
  chrome.runtime.onMessage.addListener((message, sender,
sendResponse) => {
    if (message.action === ‘getConsoleLogs’) {
      sendResponse({ logs: logs });
    }
  });
  //#endregion
  //#region Terminate process
  function handleError( ) {
    chrome.runtime.sendMessage({ action: ‘terminateProcesses’ },
function (response) {
      if (!response.success) {
        console.error(‘Failed to terminate processes:’,
response.error);
      } else {
        // console.log(‘Terminated processes successfully.’);
      }
    });
  }
  //#endregion
  //#region Capture script execution errors
  // Add error handling to capture script execution errors
  window.onerror = function (message, source, lineno, colno, error)
{
    console.error(‘Error: ${message} at
${source}:${lineno}:${colno}’, error);
    handleError( );
  };
  //#endregion
```

The above mentioned code implements additional functionality for a browser extension, on error handling and console log capture. The code begins by overriding the default ‘console.log’. The code stores the original ‘console.log’ in ‘originalLog’, then redefines ‘console.log’ to push all logged arguments into a ‘logs’ array before calling the original function. This allows the extension to capture all console logs without interfering with normal logging behavior. Next, the code sets up a message listener using the ‘chrome.runtime.onMessage.addListener( )’ function. This listener responds to a ‘getConsoleLogs’ action by sending back the captured ‘logs’ array. This mechanism allows other parts of the extension to retrieve the captured console logs on demand.

The ‘handleError( )’ function provides a centralized error handling mechanism. When called, the ‘handleError( )’ function sends a message to terminate all processes associated with the extension. The ‘handleError( )’ function uses the ‘chrome.runtime.sendMessage( )’ function to communicate with the background script, requesting process termination. The function logs an error if the termination fails. Finally, the code overrides the global ‘window.onerror’ event handler. This new handler captures any uncaught errors that occur during script execution. The ‘window.onerror’ logs the error details (message, source, line number, and column number) using the ‘console.error( )’ function. After logging the error, it calls the ‘handleError( )’ function to initiate the process termination sequence.

In operation 206, the real-time session data 124 is transferred to the customer support system 116, wherein the customer support system 116 compresses the received data into a zip file. The real-time session data 124 includes live screen data 110, which includes screenshots 112 and videos recordings 114. The real-time session data 124 also includes the details of logs in the customer device 102. The real-time session data 124 collects the data from customer device 102 and transfers to the customer support system 116.

Example for the logs collected by the real-time session data 124 for the issues in opening the Outlook application:

[30/12/2019 16:02:40.461] ************************** Creating
log file **************************

Number of

cores: 16

CPU0:

Intel (R) Xeon (R) CPU E5-2640 v4 @ 2.40GHz

Process

Affinity Mask: >1111111111111111<

Windows

version: Windows NT 6.2 (Window Server 2012)

Windows

locale: English_United Kingdom.1252

Time

zone: GMT Standard Time

Firebird

version: 9.2.10.4692

File

system: NTFS (fixed disk)

Free

space: 1009080468 k

Version:

```
KMS.KOFF64 9.2.10.4692
  [30/12/2019 16:02:40.461] ****** START ****** Common log has
just started (KMS.KOFF64 9.2.10.4692)
  [30/12/2019 16:02:40.461](4332){dbg}{mapi-provider} In
Service\ConfiguratorBase.cpp:1261
(ConfiguratorBase::verifyCommonSectionPresence)
```

| | |
|---|---|
| [#1] (common) | Common |

profile section not found - creating new one
[30/12/2019 16:02:40.461](4332){dbg}{mapi-provider} In
Service\ConfiguratorBase.cpp:1293
(ConfiguratorBase::verifyCommonSectionPresence)

| | |
|---|---|
| [#2] (common) | Common |

profile section created
[30/12/2019 16:05:45.054](4484){err}{communication} In
SCProvider\Communicator.cpp:291 (Communicator::checkAndLogResult)

| | |
|---|---|
| [#3] (common) | Exception of |

class HResultException: SCProvider\HttpConnection.cpp(131),
HttpConnection::checkStatus:

0x80042011

KOFF_E_UNAUTHORIZED (Request info: Server Ping) (Response info: status
= 401 Unauthorized)
[30/12/2019 16:05:45.054](4484){err}{synchronizer} In
SCProvider\Synchronizator.cpp:1990 (Synchronizator::testSyncCondition)

| | |
|---|---|
| [#4] (common) | Bad |

authorization - you need to start synchronizator with correct server
configuration!

HRESULT:

0x80042011 KOFF_E_UNAUTHORIZED
[30/12/2019 16:05:45.054](4332){err}{mapi-interface} In
Service\ConfiguratorCREATE.cpp:122 (ConfiguratorCREATE::testAccount)

| | |
|---|---|
| [#5] (common) | Exception of |

class HResultException: Service\ConfiguratorBase.cpp(217),
ConfiguratorBase::getServerInfo:

0x80042011

```
KOFF_E_UNAUTHORIZED
  [30/12/2019 16:06:14.851] ******* END ******* Common log has
just finished
  [30/12/2019 16:06:14.851] ***** CLOSING ***** Closing Log
just finished
  [30/12/2019 16:06:18.367] ****** START ******
“Outlook.6F12748A-4F01-418F-BB64-AA8F983E12B8” profile log has just
started (KMS.KOFF64 9.2.10.4692)(profile created at (D.M.Y H:M:S)
30.12.2019 16:6:18)
  [30/12/2019 16:06:18.367](4484){dbg}{database} In
DbServer\DatabaseOperations.cpp:353
(DatabaseOperations::initializeCommonDatabase)
```

| | |
|---|---|
| [#1] (12B8) | New common |

database created, signature is {4CC53E35-2B4F-4677-BDC4-1B0B822C8E72}
[30/12/2019 16:06:20.960](9016){err}{synchronizer} In
SCProvider\Synchronizator.cpp:1668 (Synchronizator::setOnlineInternal)

| | |
|---|---|
| [#2] (12B8) | Not found |

private store - stay in online mode without synchronization support.

HRESULT:

0x00042001 KOFF_W_NOSYNC
[30/12/2019 16:06:21.398](4484){dbg}{database} In
DbServer\DatabaseOperations.cpp:391
(DatabaseOperations::initializeStoreDatabase)

| | |
|---|---|
| [#3] (12B8) | New msgstore |

database {BAA415A9-3339-481E-B3D0-19782D1C1D8B} for store {69041519-
7DD3-419C-97BA-917C88195983} (owned by
andrew.chapman@arrowselfdrive.com) created
[30/12/2019 16:06:25.015](4484){err}{database} In
DbServer\DbSearchFolder.cpp:467 (CDbSearchFolder::AS_getSearchCriteria)

| | |
|---|---|
| [#4] (12B8) | Exception of class |

HResultException: DbServer\DbSearchFolder.cpp(440),
CDbSearchFolder::AS_getSearchCriteria:

0x80040605

MAPI_E_NOT_INITIALIZED

HRESULT:

0x80040605 MAPI_E_NOT_INITIALIZED
[30/12/2019 16:06:25.016](4332){err}{mapi-interface} In
StoreProvider\MAPIFolderImpl.cpp:554
(MAPIFolderImpl::GetSearchCriteria)

| | |
|---|---|
| [#5] (12B8) | Exception of |

class HResultException: StoreProvider\MAPIFolderImpl.cpp(538),
MAPIFolderImpl::GetSearchCriteria:

0x80040605

MAPI_E_NOT_INITIALIZED
[30/12/2019 16:06:27.293](4484){dbg}{database} In
DbServer\DatabaseOperations.cpp:391
(DatabaseOperations::initializeStoreDatabase)

| | |
|---|---|
| [#6] (12B8) | New msgstore |

```
database {604B3DB5-C86B-4201-983C-490137F0063A} for store {12AEF084-
0928-4DA2-989C-ADC3B817086D} (owned by #public) created
  [30/12/2019 16:25:47.665] ******* END *******
“Outlook.6F12748A-4F01-418F-BB64-AA8F983E12B8” profile log has just
finished
  [30/12/2019 16:25:47.665] ***** CLOSING ***** Closing Log
  [02/01/2020 08:28:51.360] ****** START ******
“Outlook.6F12748A-4F01-418F-BB64-AA8F983E12B8” profile log has just
started (KMS.KOFF64 9.2.10.4692) (profile created at (D.M.Y H:M:S)
30.12.2019 16:6:18)
  [02/01/2020 08:28:51.360](9136){err}{communication} In
SCProvider\Communicator.cpp:291 (Communicator::checkAndLogResult)
```

| | |
|---|---|
| [#1] (12B8) | POCO |

Exception Timeout : (Request info: Server Ping) (Response info: status
= 0 ) (Original result = 0x80044001)
[02/01/2020 08:28:52.423](17040){err}{scp-worker} In
SCProvider\Worker _folder.cpp:201 (SyncRequestFolder::processSyncFolder)

| | |
|---|---|
| [#2] (12B8) | Exception of |

class HResultException: SCProvider\Worker_folder.cpp(69),
SyncRequestFolder::processSyncFolder:

0x80042004

KOFF_E_NOTONLINE

Failed in

folder “Outgoing messages” (4f3baf9e-9774-47db-9dea-64236e9e6283)
[02/01/2020 11:16:08.055](9136){err}{communication} In
SCProvider\Communicator.cpp:291 (Communicator::checkAndLogResult)

| | |
|---|---|
| [#3] (12B8) | POCO |

Exception Timeout : (Request info: Server Ping) (Response info: status
= 0 ) (Original result = 0x80044001)
[02/01/2020 11:16:09.117](17040){err}{scp-worker} In
SCProvider\Worker_folder.cpp:201 (SyncRequestFolder::processSyncFolder)

| | |
|---|---|
| [#4] (12B8) | Exception of |

class HResultException: SCProvider\Worker_folder.cpp(69),
SyncRequestFolder::processSyncFolder:

0x80042004

KOFF_E_NOTONLINE

Failed in

```
folder “Outgoing messages” (4f3baf9e-9774-47db-9dea-64236e9e6283)
  [02/01/2020 16:54:01.551] ******* END *******
“Outlook.6F12748A-4F01-418F-BB64-AA8F983E12B8” profile log has just
finished
  [02/01/2020 16:54:01.551] ***** CLOSING ***** Closing Log
  [03/01/2020 11:38:24.710] ****** START ******
“Outlook.6F12748A-4F01-418F-BB64-AA8F983E12B8” profile log has just
started (KMS.KOFF64 9.2.10.4692)(profile created at (D.M.Y H:M:S)
30.12.2019 16:6:18)
  [03/01/2020 11:38:24.710](21332){err}{communication} In
SCProvider\Communicator.cpp:291 (Communicator::checkAndLogResult)
```

| | |
|---|---|
| [#1] (12B8) | POCO |

Exception Timeout : (Request info: Server Ping) (Response info: status
= 0 ) (Original result = 0x80044001)
[03/01/2020 11:38:25.898](10384){err}{scp-worker} In
SCProvider\Worker_folder.cpp:201 (SyncRequestFolder::processSyncFolder)

| | |
|---|---|
| [#2] (12B8) | Exception of |

class HResultException: SCProvider\Worker_folder.cpp(69),
SyncRequestFolder::processSyncFolder:

0x80042004

KOFF_E_NOTONLINE

Failed in

folder “Outgoing messages” (4f3baf9e-9774-47db-9dea-64236e9e6283)
[03/01/2020 14:11:21.203](3364){err}{mapi-interface} In
MapiProvider\Utilities/MapiPropImpl.h:700
(Utilities::MapiPropImpl<struct IMAPIFolder,class
MAPIFolderImpl,0>::SetProps)

| | |
|---|---|
| [#3] (12B8) | Exception of |

class HResultException: MapiProvider\Utilities/MapiPropImpl.h(1041),
Utilities::MapiPropImpl<struct IMAPIFolder,class
MAPIFolderImpl,0>::checkAccessLevel:

0x80070005

E_ACCESSDENIED
[03/01/2020 17:07:05.903] ******* END *******
“Outlook.6F12748A-4F01-418F-BB64-AA8F983E12B8” profile log has just
finished
[03/01/2020 17:07:05.903] ***** CLOSING ***** Closing Log

The customer support system 116 compresses the received data into a zip. The zip file is a compressed file format that allows for the bundling and compressing of multiple files or folders into a single file with a “.zip” extension. The zip file reduces the overall file size and makes files easier to store and share. In at least one embodiment, the customer support system 116 selects the necessary documents and chooses the “Compress to ZIP” option, which compresses the files into a single ZIP folder. For example, the customer support system 116 gathers user logs and selects the necessary log files. The customer support system 116 then triggers the “Compress to ZIP” option, which compresses these files into a single ZIP file.

In operation 208, the prompt generator 118 generates prompts 119 to guide the AI engine 120 to troubleshoot and resolve the issues faced by the customer while using the online tool 106. The prompt generator 118 modifies the prompt 119 according to the data from the user data 108. The prompts 119 are created by the prompt engineers, and the prompt generator 118 modifies the prompt 119 according to the different scenarios. Following are exemplary engineered prompts/prompt templates that are populated with data by the prompt generator 118:

### System Prompt Template

You are an AI-powered network security diagnostic assistant integrated into a browser extension support system for {product}. Your role is to analyze captured network data, screenshots, and user context to identify issues and generate executable troubleshooting plans.

### Capabilities:

Analyze network traffic patterns for anomalies
Detect certificate errors, mixed content warnings, and CORS issues
Identify potential security threats (blocked resources, suspicious requests)
Cross-reference against known security vulnerability databases
Generate step-by-step remediation plans
Search knowledge bases for relevant helpful information
Search past tickets for similar scenarios and solutions
Escalate critical security issues to human support

### Knowledge Bases Available:

{KB Lookup}

### Output Requirements:

1. Issue classification (severity: critical/high/medium/low)
2. Root cause analysis
3. Executable troubleshooting plan with specific steps
4. Expected outcomes for each step
5. Escalation criteria if automated resolution fails
   Sample Prompt with Sample Data Networking-Note Prompts are in JSON Format:

```
  {
    “prompt_type”: “network_security_diagnostic”,
    “timestamp”: “2025-10-24T14:32:18Z”,
    “user_context”: {
      “user_id”: “user_7891”,
      “session_id”: “sess_abc123”,
      “browser”: “Chrome 118.0”,
      “os”: “macOS 14.1”,
      “url_current”: “https://app.example.com/dashboard”,
      “user_action”: “Attempted to load dashboard page”,
      “error_visible”: true,
      “user_description”: “Page shows security warning and won't load completely”
    },
    “network_capture”: {
      “capture_duration_ms”: 5000,
      “total_requests”: 47,
      “failed_requests”: 3,
      “security_events”: [
        {
          “type”: “mixed_content_blocked”,
          “url”: “http://cdn.example.com/script.js”,
          “timestamp”: “2025-10-24T14:32:15Z”,
          “http_status”: “blocked”,
          “console_error”: “Mixed Content: The page at ‘https://app.example.com/dashboard’
was loaded over HTTPS, but requested an insecure script ‘http://cdn.example.com/script.js’”
        },
        {
          “type”: “certificate_error”,
          “url”: “https://api.thirdparty.com/data”,
          “timestamp”: “2025-10-24T14:32:16Z”,
          “error_code”: “NET::ERR_CERT_COMMON_NAME_INVALID”,
          “details”: “Certificate common name ‘api-old.thirdparty.com’ does not match
‘api.thirdparty.com’”
        },
        {
          “type”: “cors_error”,
          “url”: “https://analytics.partner.com/track”,
          “timestamp”: “2025-10-24T14:32:17Z”,
          “error”: “Access to fetch at ‘https://analytics.partner.com/track’ has been blocked by
CORS policy: No ‘Access-Control-Allow-Origin’ header”
        }
      ],
      “headers_suspicious”: [
        {
          “request_url”: “https://app.example.com/api/user”,
          “missing_header”: “Strict-Transport-Security”,
          “risk_level”: “medium”
        }
      ]
    },
    “screenshot_analysis”: {
      “screenshot_id”: “scr_xyz789”,
      “ocr_extracted_text”: [
        “Connection not secure”,
        “Some content has been blocked”,
        “ERR_BLOCKED_BY_CLIENT”
      ],
      “visual_elements_detected”: [
        {
          “element”: “security_warning_icon”,
          “location”: “top-left”,
          “type”: “browser_native_warning”
        },
        {
          “element”: “partial_page_load”,
          “description”: “Dashboard widgets appear incomplete, missing data visualization”,
          “affected_area”: “60% of viewport”
        }
      ],
      “dom_snapshot_hash”: “sha256:7f9d8e2a...”
    },
    “system_state”: {
      “browser_extensions_active”: [
        “AdBlocker Pro”,
        “Privacy Guard”,
        “Customer Support Assistant (this extension)”
      ],
      “console_errors_count”: 8,
      “security_warnings_count”: 3,
      “page_load_status”: “incomplete”,
      “javascript_errors”: 2
    },
    “historical_context”: {
      “user_previous_issues”: [
        {
          “date”: “2025-10-20”,
          “issue”: “CORS error on same domain”,
          “resolution”: “Browser cache cleared”,
          “success”: true
        }
      ],
      “similar_issues_database”: {
        “query”: “mixed content + certificate error + app.example.com”,
        “matches_found”: 12,
        “common_resolution”: “Update resource URLs to HTTPS”
      }
    },
    “instruction”: “Analyze all provided data including network capture, screenshot
analysis, and user context. Cross-reference against available knowledge bases (KB_SEC_001
through KB_SEC_007). Identify all security issues, determine root causes, and generate a
prioritized, executable troubleshooting plan. Each step must be specific and actionable. If issues
cannot be auto-resolved, create detailed escalation data for human support.”,
    “constraints”: {
      “max_auto_resolution_steps”: 5,
      “timeout_per_step_seconds”: 30,
      “require_user_confirmation”: [“clear_cache”, “disable_extensions”,
“modify_settings”],
      “escalation_triggers”: [“certificate_expired”, “malware_suspected”,
“authentication_breach”]
    },
    “expected_output_format”: {
      “issue_summary”: “string”,
      “severity”: “enum[critical|high|medium|low]”,
      “root_cause”: “string”,
      “affected_components”: “array”,
      “troubleshooting_plan”: {
        “steps”: [
          {
            “step_number”: “int”,
            “action”: “string”,
            “rationale”: “string”,
            “execution_type”: “enum[automated|user_guided|manual]”,
            “expected_result”: “string”,
            “kb_reference”: “string”,
            “estimated_time_seconds”: “int”,
            “rollback_available”: “boolean”
          }
        ]
      },
      “success_criteria”: “array”,
      “escalation_required”: “boolean”,
      “escalation_reason”: “string|null”
    }
  }
```

Sample Prompt with Sample CMS-Note Prompts are in JSON Format:

### Sample AI Engine 120 Output Response

```
            {
  “issue_summary”: “Multiple security-related resource loading failures detected: mixed
content blocking, certificate name mismatch, and CORS policy violation preventing dashboard
from loading completely.”,
  “severity”: “high”,
  “root_cause”: “Primary issue is mixed content blocking (HTTP resource requested from
HTTPS page). Secondary issues are third-party API certificate misconfiguration and missing
CORS headers. These are preventing critical dashboard components from loading.”,
  “affected_components”: [
    “Dashboard visualization scripts”,
    “Third-party analytics integration”,
    “Real-time data API connection”
  ],
  “confidence_score”: 0.92,
  “kb_references_consulted”: [
    “KB_SEC_003: Mixed Content Issue Database - Pattern Match: 94%”,
    “KB_SEC_001: SSL/TLS Certificate Errors - Section 4.2: Common Name Mismatch”,
    “KB_SEC_002: CORS Policy Violations - Standard Resolution Protocols”
  ],
  “troubleshooting_plan”: {
    “plan_id”: “tsp_sec_001_20251024_143218”,
    “total_steps”: 4,
    “estimated_total_time_seconds”: 90,
    “steps”: [
      {
        “step_number”: 1,
        “action”: “Update insecure resource URL from HTTP to HTTPS”,
        “rationale”: “The script at ‘http://cdn.example.com/script.js’ is blocked due to mixed
content policy. Analysis shows this CDN supports HTTPS. Updating to
‘https://cdn.example.com/script.js’ will resolve the primary blocking issue.”,
        “execution_type”: “automated”,
        “technical_details”: {
          “method”: “DOM manipulation via extension”,
          “target”: “script[src=‘http://cdn.example.com/script.js’]”,
          “modification”: “Update src attribute to HTTPS protocol”,
          “safety_check”: “Verify HTTPS endpoint responds with 200 OK before
modification”
        },
        “expected_result”: “Script loads successfully, console error ‘Mixed Content’
disappears, dashboard widgets begin rendering”,
        “kb_reference”: “KB_SEC_003.4.1: Mixed Content Resolution - Protocol Upgrade”,
        “estimated_time_seconds”: 15,
        “rollback_available”: true,
        “success_indicators”: [
          “HTTP request count decreases by 1”,
          “Console error count decreases by 1”,
          “Script execution detected in performance timeline”
        ]
      },
      {
        “step_number”: 2,
        “action”: “Clear browser cache and reload page”,
        “rationale”: “Historical data shows user had similar CORS issue on 2025-10-20
resolved by cache clearing. Cached responses may contain outdated headers or security
policies.”,
        “execution_type”: “user_guided”,
        “technical_details”: {
          “cache_scope”: “app.example.com domain only”,
          “clear_types”: [“cached_images”, “cached_scripts”, “cached_stylesheets”],
          “preserve”: [“cookies”, “localStorage”, “session_data”]
        },
        “user_instructions”: [
          “Click ‘Clear Cache’ button below”,
          “Wait for confirmation message”,
          “Page will automatically reload”
        ],
        “expected_result”: “Fresh resources loaded without cached security policy
conflicts”,
        “kb_reference”: “KB_SEC_002.3.7: CORS Cache-Related Issues”,
        “estimated_time_seconds”: 20,
        “rollback_available”: false,
        “requires_user_confirmation”: true
      },
      {
        “step_number”: 3,
        “action”: “Monitor third-party API certificate issue and provide user guidance”,
        “rationale”: “Certificate common name mismatch at ‘api.thirdparty.com’ is outside
user's control. This is a server-side configuration issue requiring vendor resolution. However, we
can verify if this is blocking critical functionality.”,
        “execution_type”: “automated_check”,
        “technical_details”: {
          “method”: “Attempt API call with fallback endpoints”,
          “fallback_urls”: [
            “https://api-old.thirdparty.com/data”,
            “https://api-backup.thirdparty.com/data”
          ],
          “timeout_ms”: 5000
        },
        “expected_result”: “Determine if dashboard can function without this API or if
alternative endpoint works”,
        “kb_reference”: “KB_SEC_001.4.2: Certificate Name Mismatch - Client-Side
Mitigation”,
        “estimated_time_seconds”: 10,
        “rollback_available”: false,
        “escalation_note”: “If critical functionality blocked, escalate to human support with
vendor contact recommendation”
      },
      {
        “step_number”: 4,
        “action”: “Verify dashboard functionality and document remaining issues”,
        “rationale”: “After steps 1-3, verify if dashboard loads completely. Any remaining
issues require human support.”,
        “execution_type”: “automated”,
        “technical_details”: {
          “checks”: [
            “Console error count < 2”,
            “Failed network requests < 1”,
            “Visual elements loaded > 90%”,
            “JavaScript errors == 0”
          ]
        },
        “expected_result”: “Dashboard fully functional or clear identification of remaining
blockers”,
        “kb_reference”: “KB_SEC_007: Verification Protocols”,
        “estimated_time_seconds”: 5,
        “rollback_available”: false,
        “success_indicators”: [
          “Page load status == ‘complete’”,
          “All dashboard widgets visible”,
          “No security warnings in browser UI”
        ]
      }
    ]
  },
  “success_criteria”: [
    “Console security errors reduced to zero”,
    “All dashboard visualization components load successfully”,
    “No browser security warnings visible”,
    “Network request success rate > 95%”
  ],
  “automated_resolution_possible”: true,
  “requires_user_interaction”: true,
  “requires_user_confirmation_steps”: [2],
  “escalation_required”: false,
  “escalation_reason”: null,
  “conditional_escalation”: {
    “condition”: “If Step 3 determines third-party API is critical and unavailable”,
    “escalation_priority”: “medium”,
    “recommended_ticket_data”: {
      “title”: “Third-party API certificate misconfiguration blocking dashboard”,
      “category”: “external_dependency”,
      “vendor”: “thirdparty.com”,
      “technical_details”: “Certificate common name mismatch - cert issued for ‘api-
old.thirdparty.com’ but accessed via ‘api.thirdparty.com’”,
      “user_impact”: “Dashboard data visualization unavailable”,
      “suggested_action”: “Contact ThirdParty vendor to update SSL certificate or provide
correct API endpoint”
    }
  },
  “execution_timeline”: {
    “start_time”: “2025-10-24T14:32:19Z”,
    “estimated_completion”: “2025-10-24T14:33:49Z”,
    “checkpoints”: [
      {“step”: 1, “time”: “14:32:34Z”},
      {“step”: 2, “time”: “14:32:54Z”},
      {“step”: 3, “time”: “14:33:04Z”},
      {“step”: 4, “time”: “14:33:09Z”}
    ]
  },
  “monitoring_plan”: {
    “post_resolution_monitoring_duration_minutes”: 5,
    “metrics_to_track”: [
      “network_request_success_rate”,
      “console_error_count”,
      “page_load_time”,
      “user_interaction_success”
    ],
    “recheck_triggers”: [
      “If console errors reappear within 5 minutes”,
      “If user reports continued issues”,
      “If network failure rate exceeds 5%”
    ]
  },
  “learning_data”: {
    “issue_pattern_id”: “SEC_MIXED_CONTENT_001”,
    “resolution_confidence”: 0.92,
    “similar_cases_resolved”: 147,
    “average_resolution_time_seconds”: 65,
    “success_rate”: 0.94,
    “feedback_requested”: true
  }
  }
```

In operation 210, the customer support system 116 transfers the prompts along with the zip file to the AI engine 120. The AI engine 120 analyzes the real-time session data 124 related to the issue to understand the reason behind the occurrence of the issue.

The AI engine 120 uses pattern recognition and anomaly detection techniques to identify issues. The pattern recognition is the process by which the AI engine 120 identifies regularities or recurring structures within data, images, or sequences. The pattern recognition involves analyzing input data to detect consistent patterns. Machine learning algorithms are used to perform pattern recognition by learning from examples and improving their accuracy over time. The anomaly detection is the process of identifying data points, events, or patterns that deviate from the expected norm within a database. The anomaly detection uses algorithms to analyze data and flag unusual or rare occurrences that may indicate errors, fraud, or potential issues. The AI engine 120 for the resolution of issues also analyzes the HAR files.

In operation 212, the AI engine 120 generates a response based on the analysis, wherein the response includes one or more steps allowing the customer to be able to troubleshoot and resolve the issue. For example, if a customer reports that an application keeps crashing on their customer device 102, the AI engine 120 examines the information provided, by the customer support system 116. The AI engine 120, based on this analysis, suggests specific actions. The AI engine 120 might advise the customer to first update the application to the latest version, then check for any conflicting programs running in the background, or clear the cache and temporary files. If the issue persists, the AI engine 120 guides the customer to initiate the customer ticket 122. In at least one embodiment, the AI engine 120 will automatically resolve the issues after analyzing the issues.

In at least one embodiment, the AI engine 120 resolves the issues based on frame-by-frame analysis and in real time. The AI engine 120 checks each frame in the videos recordings 114 and screenshots 112 to identify the issues and resolve the issues. The issues will be resolved in real-time by the AI engine 120, or if the AI engine 120 is not able to resolve the issues, then the AI engine 120 will raise a ticket to the support ticket 122 in real-time.

In at least one embodiment, the AI engine 120 uses the user data 108 for training; thus, the AI engine 120 can learn from the accumulated data for improving the analysis and effectiveness of the automated resolutions. For example, when a user uploads videos with certain recurring issues, the AI engine 120 analyzes these problems and learns from the patterns. Over time, the AI engine 120 becomes better at recognizing and resolving similar issues more quickly. The AI engine 120, through learning from the user data 108, will also become eligible to solve the similar issues automatically in real-time.

In operation 214, the AI engine 120 delivers the generated response to the customer through the user interface 104, which is accessible while using the online tool 106. The generated response can include how the issues need to be solved manually or the data for automatically troubleshooting the issues. In at least one embodiment, the response can also be sent to a different device's user interface 104. For example, if the user cannot access the online tool 106, they can initiate the process through a mobile application. In this case, the AI engine 120 provides the output directly to the mobile application's user interface 104.

In operation 216, the support ticket 122 creates a ticket for customer support if the AI engine 120 is unable to resolve the issue or if the customer believes the issue is not resolved. If the AI engine 120 encounters a problem the AI engine 120 cannot handle or if the AI engine 120 determines that manual intervention is required, the AI engine 120 immediately generates the support ticket 122. Additionally, if the customer feels that the issue remains unresolved despite the AI engine 120 attempt to fix issues, the customer can manually request support. In either case, the support ticket 122 includes relevant details about the issue and is forwarded to the customer support team for further action.

The code represents the manifest file for a Chrome extension:

```
{
  “manifest_version”: 3,
  “name”: “GFI ATLAS Client”,
  “version”: “1.0”,
  “description”: “A triage mechanism which offers resolution
      beforehand without having to submit a suport ticket.”,
  “permissions”: [
    “activeTab”,
    “scripting”,
    “debugger”,
    “tabs”,
    “storage”,
    “tabCapture”
  ],
  “background”: {
    “service_worker”: “background.js”
  },
  “action”: {
    “default_popup”: “popup.html”,
    “default_title”: “GFI ATLAS Client”
  },
  “host_permissions”: [
    “<all_urls>”
  ],
  “content_scripts”: [
    {
      “matches”: [“<all_urls>”],
      “js”: [“content.js”]
    }
  ],
  “icons”: {
    “16”: “icon16.png”,
    “48”: “icon48.png”,
    “128”: “icon128.png”
  }
}
```

The above JSON code describes the manifest for the browser extension. The exemplary automated troubleshooting and resolution system requires the following permissions to function properly: active tab, script execution, web page debugging, tab management, data storage, and tab content capture. These permissions allow for deep interaction with the customer device 102 and enable the collection of necessary information for issue resolution.

A background script, “background.js”, runs continuously to handle events and manage the the exemplary automated troubleshooting and resolution system's functionality. The “background.js” script operates independently of any particular web page or window. The exemplary automated troubleshooting and resolution system can be accessed through chrome toolbar through a button. When customers click this button, a popup window opens, allowing them to interact with the exemplary automated troubleshooting and resolution system.

Content scripts injected into all web pages allow the exemplary automated troubleshooting and resolution system to read and modify web content directly. This capability is crucial for identifying and potentially resolving issues on the fly. The exemplary automated troubleshooting and resolution system can operate on all websites, as indicated by the “<all_urls>” host permission. This broad access allows it to provide support across the entire web.

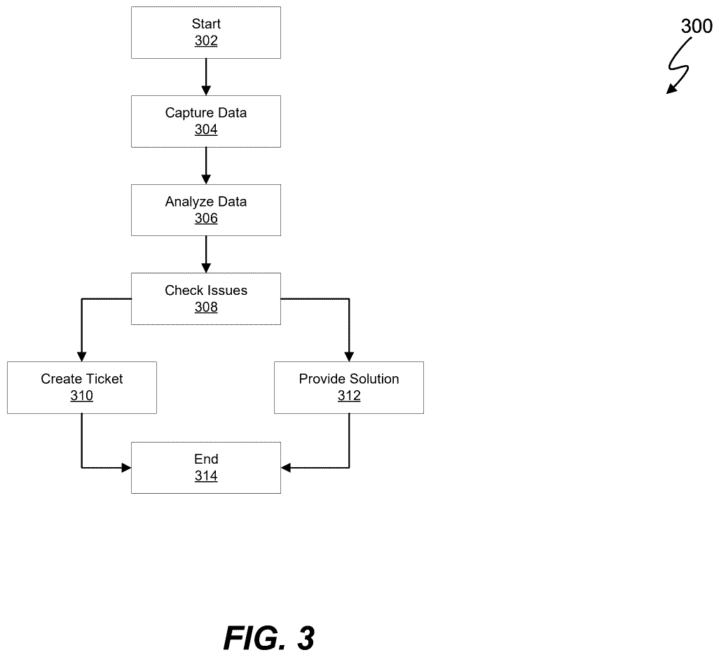

FIG. 3 depicts a process flow 300 for the exemplary automated troubleshooting and resolution method, which is an embodiment of the exemplary automated troubleshooting and resolution method of FIG. 2. The process begins at the start 302 node. From the start 302 node, the flow moves to a capture data 304 step. In capturedata 304 step, the exemplary automated troubleshooting and resolution system collects necessary information or data relevant to the task, such as the user data 108, which includes real-time session data 124. After the capturedata step 304, the process advances to a analyzedata 306 step. During the analyzedata 306 step, examine and process the collected data to gain insights or identify potential issues. The flow then progresses to checkissues 308 step, which evaluates the analyzed data and provides solutions to the issues with the help of the AI engine 120. If the issue is not solved or not able to be given a solution by the AI engine 120, then the AI engine 120 will raise the ticket to solve the issue manually. If the AI engine 120 is able to solve the issues within the checkissues step 308, then the solution will be provided to the user interface 104 through the providesolution 312 step. If the AI engine 120 is not able to give the solution, then the issue is solved manually in a createticket 310 step. Both the createticket 310 step and providesolution 312 step ultimately lead to the end 314 node, signifying the completion of the process.

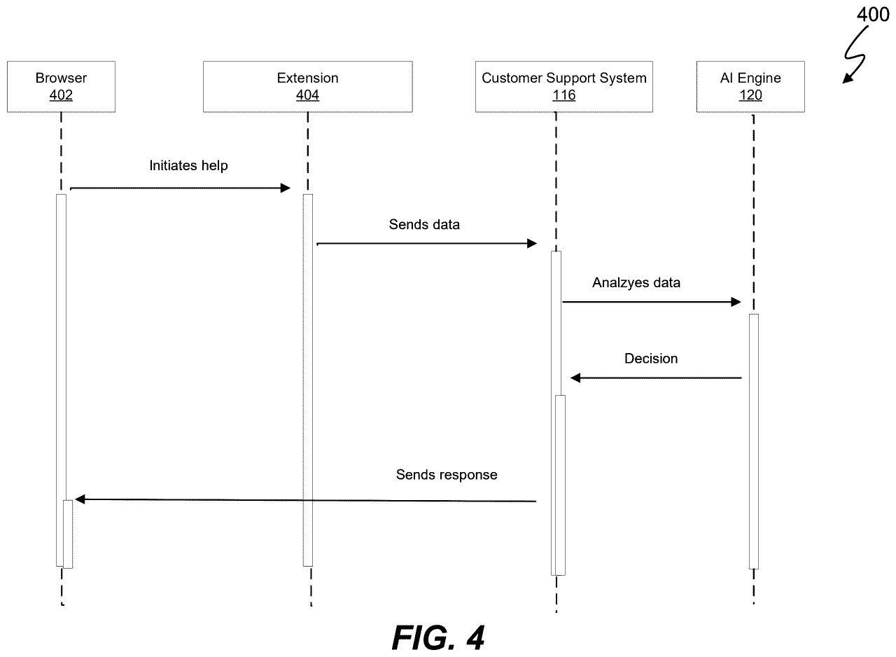

FIG. 4 depicts the information flow 400 for the exemplary automated troubleshooting and resolution method, which is an embodiment of the exemplary automated troubleshooting and resolution method of FIG. 2. A browser 402 initiates a help request to an extension 404. This action triggers the flow of information through the exemplary automated troubleshooting and resolution system. An extension 404 sends the data to the customer support system 116. Sending data to the customer support system 116 involves transmitting relevant information gathered from the browser 402 or user input. The customer support system 116 then forwards the data to the AI engine 120 for analysis. The AI engine 120 processes the received information, applying its algorithms and knowledge base to understand the request and formulate a decision.

The AI engine 120, completing its analysis, sends its decision back to the customer support system 116. The decision contains the answer or solution to the initial help request. Finally, the customer support system 116 delivers the AI engine 120 response back to the browser.

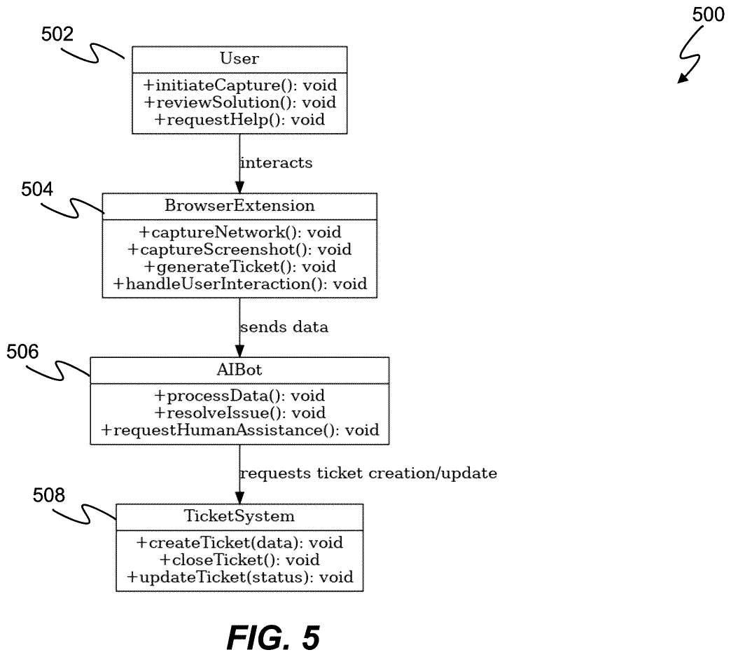

FIG. 5 depicts a data structure 500 for the exemplary automated troubleshooting and resolution system. The User 502 node includes methods for initiating captures, reviewing solutions, and requesting help. The initiating captures include the initiation of the collection of data from the customer device 102, which includes real-time session data 124. The reviewing of the solution means checking the solution given from the AI engine 120 after the processing. The requesting help denotes raising the support ticket 122 when the user is not satisfied with the solution given by the AI engine 120. The user 502 node encapsulates the actions a user can perform within the exemplary automated troubleshooting and resolution system.

A browser extension 504 includes methods for capturing network activity, taking the screenshots 112, generating tickets, and handling user interactions. This component serves as the primary interface between the customer's browser and the rest of the exemplary automated troubleshooting and resolution system. The AIBot 506 node contains processing data, resolving issues, and requesting human assistance when needed. This component handles the intelligent analysis and decision-making within the exemplary automated troubleshooting and resolution system. A ticket system 508 node encompasses methods for creating, closing, and updating tickets. The ticket system 508 manages the workflow of issue tracking and resolution.

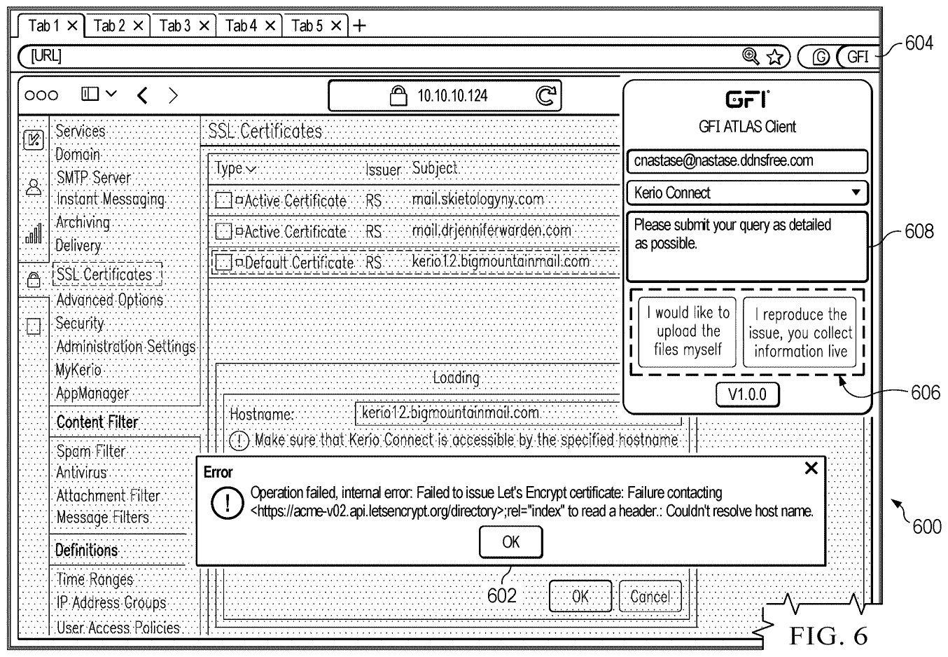

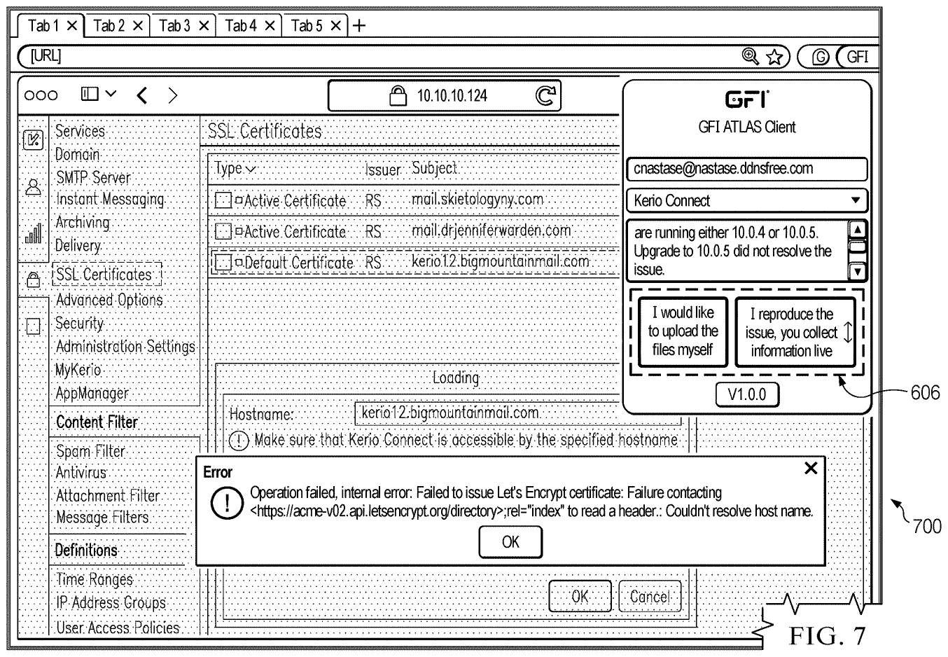

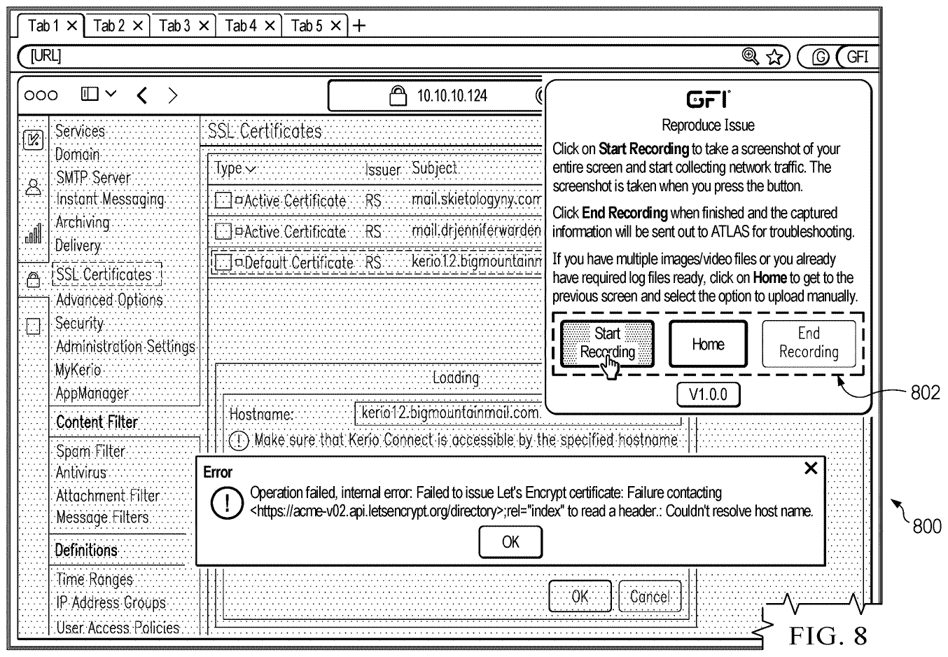

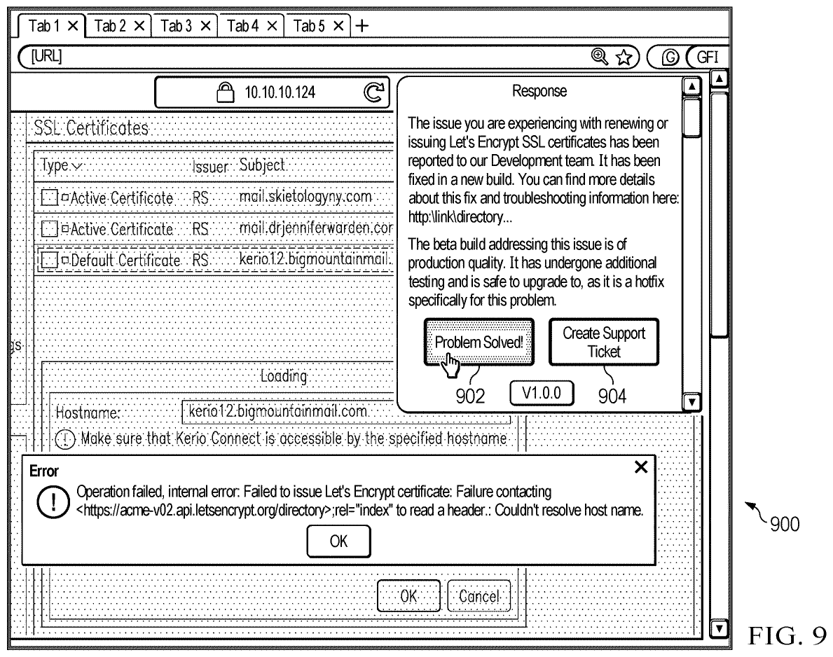

FIG. 6-9 depicts the user interface 104 with an error message and a popup page from the exemplary automated troubleshooting and resolution system. The error message 602 displays the issue occurring with the webpage, and when the customer accesses a browser extension 604, the exemplary automated troubleshooting and resolution system popsup page. On the popup page, there is a space for entering complaint 608 and part 606 provides various options for uploading the user data 108. In FIG. 7, after the user enters a comment, and part 606 becomes accessible. Part 606 presents two options: one for manually uploading the file and the other for automatically retrieving the necessary file from the customer device 102. In FIG. 8, the interface of the popup page appears for the customer selecting manual upload. Part 802 displays the recording options, which include three main buttons: start recording, home, and end recording. If the customer chooses “start recording,” the user data 108 begins capturing the data from the customer's device 102. The customer can stop the recording using the “end recording” option. In FIG. 9, the popup page provides two options for the customer to check whether the problem has been resolved. If the issue is solved, the customer can select “Problem Solved” 902. If manual assistance is needed, the customer can choose the “Create Support Ticket” 904 option.

The JavaScriptt code sets up a web application for customer support interaction:

The above mentioned JavaScript code starts by adding an event listener for when the webpage content is fully loaded. Within this listener, the JavaScript code selects various HTML elements using their IDs and stores them in variables for later use. These elements include screens, buttons, input fields, and other user interface 104 components. The JavaScript code then checks for any stored response content in the browser's local storage. If found, JavaScript code displays this content in the response screen and adjusts the visibility of 606 part. The JavaScript code handles the visual elements that show customer when the website is loading or sending messages. The JavaScript code also makes sure that customer can close these messages if customer don't want to see them anymore.

The JavaScript code fetches a list of products from a server using the Fetch API. The JavaScript code populates a select element with these products and sets up an event listener to send the selected product name to a background script when changed. The JavaScript code includes form validation logic to ensure all required fields are filled before enabling certain buttons. The JavaScript code also defines functions for initializing a new session and transitioning between different screens in the application. Event listeners are set up for various buttons and input fields. These handle actions like uploading files, starting and stopping recording sessions, submitting queries, and navigating between screens.

The script includes logic for handling file uploads. When a file is selected, The JavaScript code reads the file content and sends it to a background script for processing. The JavaScript code then displays the uploaded file name in the online tool 106. The JavaScript code sets up a runtime message listener to handle messages from background.js scripts, such as updating ticket IDs or handling specific status codes. Finally, the JavaScript code checks the current recording status and screen state when the application loads, and sets up the online tool 106 accordingly.

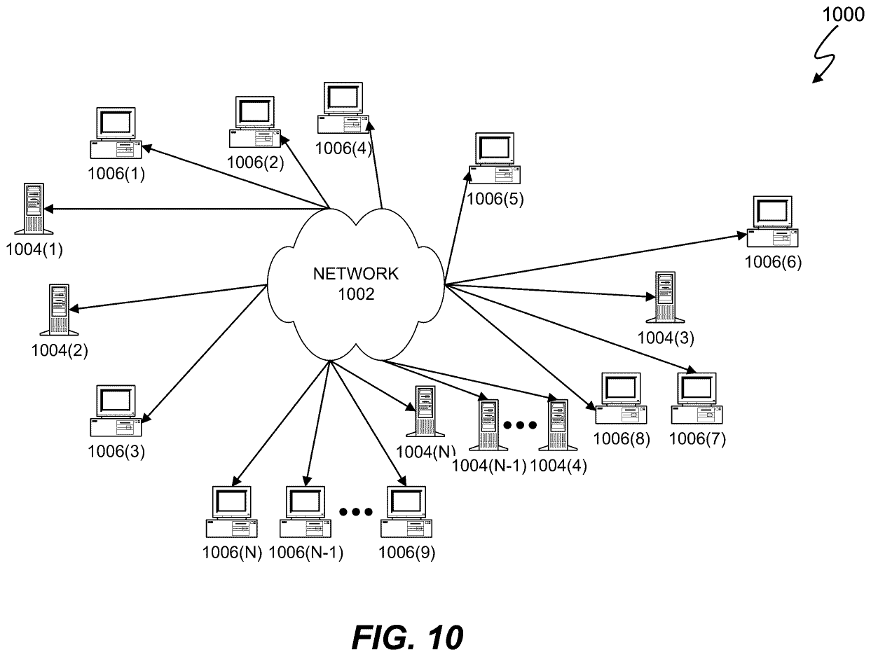

FIG. 10 is a block diagram illustrating a network environment in which an exemplary automated troubleshooting and resolution system 100 and an exemplary automated troubleshooting and resolution method 200 may be practiced. Network 1002 (e.g. a private wide area network (WAN) or the Internet) includes a number of networked server computer systems 1004(1)-(N) that are accessible by client computer systems 1006(1)-(N), where N is the number of server computer systems connected to the network. Communication between client computer systems 1006(1)-(N) and server computer systems 1004(1)-(N) typically occurs over a network, such as a public switched telephone network over asynchronous digital subscriber line (ADSL) telephone lines or high-bandwidth trunks, for example communications channels providing T1 or OC3 service. Client computer systems 1006(1)-(N) typically access server computer systems 1004(1)-(N) through a service provider, such as an internet service provider (“ISP”) by executing application specific software, commonly referred to as a browser, on one of client computer systems 1006(1)-(N).

Client computer systems 1006(1)-(N) and/or server computer systems 1004(1)-(N) are specialized computer programmed to improve conventional computer systems to implement and utilize the exemplary automated troubleshooting and resolution system 100 and the exemplary automated troubleshooting and resolution method 200. The type of computer system that can be specially programmed to implement and utilize the exemplary automated troubleshooting and resolution system 100 and the exemplary automated troubleshooting and resolution method 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the exemplary automated troubleshooting and resolution system 100 and the exemplary automated troubleshooting and resolution method 200 can be implemented using code stored in a tangible, non-transient computer readable medium and executed by one or more processors. In at least one embodiment, the exemplary automated troubleshooting and resolution system 100 and the exemplary automated troubleshooting and resolution method 200 can be implemented completely in hardware using, for example, logic circuits and other circuits including field programmable gate arrays.

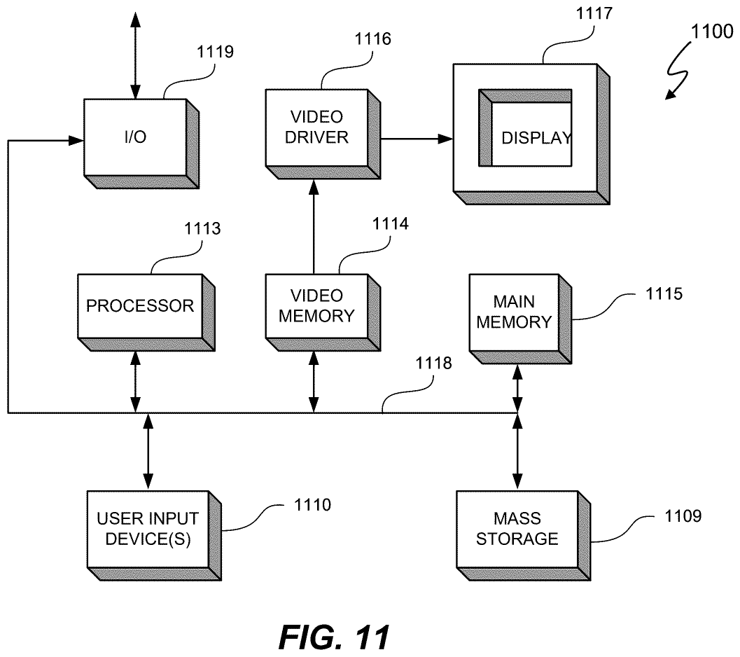

Embodiments of the exemplary automated troubleshooting and resolution system 100 and the exemplary automated troubleshooting and resolution method 200 can be implemented on a computer system such as a special-purpose, special-programmed computer 1100 illustrated in FIG. 11. Input user device(s) 1110, such as a keyboard and/or mouse, are coupled to a bi-directional system bus 1118. The input user device(s) 1110 are for introducing user input to the computer system and communicating that user input to processor 1113. The computer system of FIG. 11 generally also includes a non-transitory video memory 1114, non-transitory main memory 1115, and non-transitory mass storage 1124, all coupled to bi-directional system bus 1118 along with input user device(s) 1110 and processor 1113. The mass storage 1124 may include both fixed and removable media, such as a hard drive, one or more CDs or DVDs, solid state memory including flash memory, and other available mass storage technology. Bus 1118 may contain, for example, 32 of 64 address lines for addressing video memory 1114 or main memory 1115. The system bus 1118 also includes, for example, an n-bit data bus for transferring DATA between and among the components, such as CPU 1124, main memory 1115, video memory 1114 and mass storage 1124, where “n” is, for example, 32 or 64. Alternatively, multiplex data/address lines may be used instead of separate data and address lines.

I/O device(s) 1119 may provide connections to peripheral devices, such as a printer, and may also provide a direct connection to a remote server computer systems via a telephone link or to the Internet via an ISP. I/O device(s) 1119 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1124, into main memory 1115 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1113, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1115 is comprised of dynamic random access memory (DRAM). Video memory 1114 is a dual-ported video random access memory. One port of the video memory 1114 is coupled to video amplifier 1116. The video amplifier 1116 is used to drive the display 1117. Video amplifier 1116 is well known in the art and may be implemented by any suitable means. This circuitry converts pixel DATA stored in video memory 1114 to a raster signal suitable for use by display 1117. Display 1117 is a type of monitor suitable for displaying graphic images.

The computer system described above is for purposes of example only. The exemplary automated troubleshooting and resolution system 100 and the exemplary automated troubleshooting and resolution method 200 may be implemented in any type of computer system or programming or processing environment. It is contemplated that the exemplary automated troubleshooting and resolution system 100 and the exemplary automated troubleshooting and resolution method 200 might be run on a stand-alone computer system, such as the one described above. The exemplary automated troubleshooting and resolution system 100 and the exemplary automated troubleshooting and resolution method 200 might also be run from a server computer systems system that can be accessed by a plurality of client computer systems interconnected over an intranet network. Finally, the exemplary automated troubleshooting and resolution system 100 and the exemplary automated troubleshooting and resolution method 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for guiding an AI engine for providing automated troubleshooting and resolution in a customer support environment comprising:
executing code using one or more processors of a computer system to cause the computer system to perform operations comprising:
integrating a framework within an online tool to initiate communication between the online tool and a customer support system for:
capturing user data including real-time session data capturing one or more issues faced by the customer while using the online tool, wherein the real-time session data includes live screen data including screenshots and videos recordings from the customer device capturing issues for which customer support is required;
transferring the real-time session data to the customer support system, wherein the customer support system compresses the received data into a zip file;
generating prompts to guide the AI engine to troubleshoot and resolve the issues faced by the customer while using the online tool;
transferring the prompts along with the zip file to the AI engine for:
analyzing the real-time session data related to the issue to understand the reason behind the occurrence of the issue;
generating a response based on the analysis, wherein the response includes one or more steps allowing the customer to be able to troubleshoot and resolve the issue;
delivering the generated response to the customer via a user interface accessible while using the online tool, wherein the response troubleshoots and resolves the issues related to the online tool; and
creating a ticket for customer support if the AI engine is unable to resolve the issue or if the customer believes the issue is not resolved.

2. The method of claim 1, wherein the user data can be accrued through a browser extension, mobile application, or web page.

3. The system of claim 1, wherein the method troubleshoots and resolves the issues based on frame-by-frame analysis and automatically.

4. The method of claim 1, wherein the method provides an option for the customer to choose between capturing the user data by manually triggering or allowing the customer device to continuously monitor and collect the user data.

5. The method of claim 4, wherein, if continuous monitoring is required, the customer device can periodically capture the live screen data to track the health of the user applications.

6. The method of claim 1, wherein the user data is used for training the AI engine;
thus, the AI engine can learn from the accumulated data for improving the analysis and effectiveness of the automated resolutions.

7. The method of claim 1, wherein the method ensures data privacy and security during capture and transferring data.

8. The method of claim 1, wherein the resolution of issues further includes analyzing a HAR file via the AI engine to provide additional insights.

9. The method of claim 1, wherein the AI engine uses pattern recognition and anomaly detection techniques to identify issues.

10. A system for guiding an AI engine for providing automated troubleshooting and resolution in a customer support environment comprising:
one or more processors of a computer system;
memory, coupled to the one or more processors, that stores code and execution of the code by the one or more processors causes the computer system to perform operations comprising;
integrating a framework within an online tool to initiate communication between the online tool and a customer support system for:
capturing user data including real-time session data capturing one or more issues faced by the customer while using the online tool, wherein the real-time session data includes live screen data including screenshots and videos recordings from the customer device capturing issues for which customer support is required;
transferring the real-time session data to the customer support system, wherein the customer support system compresses the received data into a zip file;
generating prompts to guide the AI engine to troubleshoot and resolve the issues faced by the customer while using the online tool;
transferring the prompts along with the zip file to the AI engine for:
analyzing the real-time session data related to the issue to understand the reason behind the occurrence of the issue;
generating a response based on the analysis, wherein the response includes one or more steps allowing the customer to be able to troubleshoot and resolve the issue;
delivering the generated response to the customer via a user interface accessible while using the online tool, wherein the response troubleshoots and resolves the issues related to the online tool; and
creating a ticket for customer support if the AI engine is unable to resolve the issue or if the customer believes the issue is not resolved.

11. The system of claim 10, wherein the user data can be accrued through a browser extension, mobile application, or web page.

12. The system of claim 10, wherein the system troubleshoots and resolves the issues based on frame-by-frame analysis and in real time.

13. The system of claim 10, wherein the system provides an option for the customer to choose between capturing the user data by manually triggering or allowing the customer device to continuously monitor and collect the user data.

14. The system of claim 13, wherein, if continuous monitoring is required, the customer device can periodically capture the live screen data to track the health of the user applications.

15. The system of claim 10, wherein the user data is used for training the AI engine; thus, the AI engine can learn from the accumulated data for improving the analysis and effectiveness of the automated resolutions.

16. The system of claim 10, wherein the system ensures data privacy and security during capture and transferring data.

17. The system of claim 10, wherein the resolution of issues further includes analyzing a HAR file via the AI engine to provide additional insights.

18. The system of claim 10, wherein the AI engine uses pattern recognition and anomaly detection techniques to identify issues.
